(19) United States
(12) Patent Application Publication
(10) Pub. No.: US 2025/0112349 A1
(43) Pub. Date: Apr. 3, 2025

(54) BATTERY AND METHOD OF MANUFACTURING THEREOF

(71) Applicant: TOYOTA JIDOSHA KABUSHIKI KAISHA, Aichi-ken (JP)

(72) Inventors: Yosuke SHIMURA, Nagakute-shi, Aichi-ken (JP); Takahiko NAKANO, Nagoya-shi, Aichi-ken (JP); Hirokazu TAKEUCHI, Toyota-shi, Aichi-ken (JP); Masato NODA, Toyota-shi, Aichi-ken (JP); Atsushi SUGIHARA, Toyota-shi, Aichi-ken (JP); Jun IZUMI, Toyota-shi, Aichi-ken (JP); Yuka YOKOI, Nagoya-shi, Aichi-ken (JP)

(21) Appl. No.: 18/830,582

(22) Filed: Sep. 11, 2024

(30) Foreign Application Priority Data
Oct. 2, 2023 (JP) 2023-171480

(51) Int. Cl. H01M 50/636; H01M 10/04; H01M 50/618

(52) U.S. Cl. CPC H01M 50/636; H01M 10/04; H01M 50/618

(57) ABSTRACT

A method of manufacturing a battery, comprising, a joining step of joining together superposed peripheral edge portions of an exterior body that accommodates an electrode body at an interior thereof, and nipping and welding one end portion of a resin hollow member between the peripheral edge portions; and a supplying step of supplying an electrolytic solution into the interior of the exterior body from a supply path of the hollow member.

### CROSS-REFERENCE TO RELATED APPLICATION

This application is based on and claims priority under 35 USC 119 from Japanese Patent Application No. 2023-171480 filed on Oct. 2, 2023, the disclosure of which is incorporated by reference herein.

### BACKGROUND

### Technical Field

The present disclosure elates to a battery and a method of manufacturing thereof.

### Related Art

There has conventionally been known a method of manufacturing a battery in which, after an electrolytic solution is injected from an injection port that is structured by an unsealed portion of a laminated exterior body, the injection port is sealed by welding (see, for example, Japanese Patent Application Laid-Open (JP-A) No. 2000-285882).

However, if the injection port through which the electrolytic solution is injected is structured by an unsealed portion of a laminated exterior body, a step for removing adhered matter that has adhered to the injection port is necessary.

### SUMMARY

Thus, an object of the present disclosure is to provide a battery in which the work of injecting an electrolytic solution into the interior of an exterior body can be carried out easily, and a method of manufacturing the battery.

In order to achieve the above-described object, a battery of a first aspect relating to the present disclosure has: an exterior body that accommodates an electrode body at an interior of the exterior body, and at which superposed peripheral edge portions are joined together; and a resin hollow member having a supply path for supplying an electrolytic solution into the interior of the exterior body, and nipped between the superposed peripheral edge portions of the exterior body, and welded to the peripheral edge portions.

In accordance with the battery of the first aspect, the hollow member, which is made of resin and has a supply path for supplying an electrolytic solution into the interior of the exterior body, is nipped between peripheral edge portions, which are superposed one on another, of the exterior body that accommodates an electrode body at the interior thereof, and the hollow member is welded to the peripheral edge portions. Accordingly, as compared with a case in which the injection port is structured by an unsealed portion of the exterior body, the work of injecting an electrolytic solution into the interior of the exterior body is easy.

A battery of a second aspect relating to the present disclosure is the battery of the first aspect, wherein a melting point of a resin material configuring the hollow member is higher than a melting point of the peripheral edge portions.

In accordance with the battery of the second aspect, the melting point of the resin material that structures the hollow member is higher than the melting point of the peripheral edge portions of the exterior body. Accordingly, at the time of joining the peripheral edge portions of the exterior body, there is no concern that the problem of the hollow member melting will arise.

A method of manufacturing a battery of a third aspect relating to the present disclosure has: a joining step of joining together superposed peripheral edge portions of an exterior body that accommodates an electrode body at an interior of the exterior body, and nipping and welding one end portion of a hollow member between the peripheral edge portions; and a supplying step of supplying an electrolytic solution into the interior of the exterior body from a supply path of the hollow member.

In accordance with the method of manufacturing a battery of the third aspect, an electrolytic solution is supplied into the interior of the exterior body from the supply path of the hollow member whose one end portion is nipped and welded between the peripheral edge portions of the exterior body that accommodates an electrode body at the interior thereof. Accordingly, as compared with a case in which the injection port is structured by an unsealed portion of the exterior body, the work of injecting an electrolytic solution into the interior of the exterior body is easy.

A method of manufacturing a battery of a fourth aspect relating to the present disclosure is the method of manufacturing a battery of the third aspect, wherein, in the joining step, the hollow member is welded between the peripheral edge portions in a state in which a rod-shaped member is inserted through the supply path that includes the one end portion, and, after welding, the rod-shaped member is pulled out.

In accordance with the method of manufacturing a battery of the fourth aspect, at the time of welding the one end portion of the hollow member between the peripheral edge portions, the welding is carried out in a state in which the rod-shaped member is inserted through the supply path that includes that one end portion. Then, the rod-shaped member is pulled out after the welding. Accordingly, the supply path of the hollow member is properly ensured, and the interior and the exterior of the exterior body are made to communicate properly.

A method of manufacturing a battery of a fifth aspect relating to the present disclosure is the method of manufacturing a battery of the fourth aspect that has a pressure-reducing step of, after pulling the rod-shaped member out, reducing pressure of the interior of the exterior body.

In accordance with the method of manufacturing a battery of the fifth aspect, after the rod-shaped member is pulled out, the pressure of the interior of the exterior body is reduced. Accordingly, in the supplying step that is after that, an electrolytic solution is smoothly supplied into the interior of the exterior body.

A method of manufacturing a battery of a sixth aspect relating to the present disclosure is the method of manufacturing a battery of any one of the third through fifth aspects that has: a cutting step of, after supplying the electrolytic solution into the interior of the exterior body, cutting the hollow member that is projecting out from the peripheral edge portions; and a sealing step of crushing and welding the one end portion of the hollow member that is nipped and remains between the peripheral edge portions, and sealing the exterior body.

In accordance with the method of manufacturing a battery of the sixth aspect, after an electrolytic solution is supplied into the interior of the exterior body, the hollow member that is projecting out from the peripheral edge portions of the exterior body is cut. Then, the one end portion of the hollow member, which is nipped and remains between the peripheral edge portions, is crushed and welded, and the exterior body is sealed. Accordingly, at the manufactured battery, as before, the ability to save on space is maintained.

As described above, in accordance with the present disclosure, the work of injecting an electrolytic solution into the interior of an exterior body can be carried out easily.

### BRIEF DESCRIPTION OF THE DRAWINGS

Exemplary embodiments of the present disclosure will be described in detail based on the following figures, wherein:

FIG. 1 is a schematic plan view illustrating an electric vehicle that is equipped with a battery relating to a present embodiment;

FIG. 2 is a schematic perspective view illustrating the structure of a battery module relating to the present embodiment;

FIG. 3 is a schematic plan view illustrating the structure of the battery module relating to the present embodiment in a state in which an upper cover has been removed therefrom;

FIG. 4 is a schematic front view illustrating the structure of a battery cell, which is accommodated in the battery module relating to the present embodiment, as seen from a thickness direction;

FIG. 5 is a schematic sectional view illustrating a step of manufacturing the battery relating to the present embodiment;

FIG. 6 is a schematic sectional view illustrating a step of manufacturing the battery relating to the present embodiment;

FIG. 7 is a schematic sectional view illustrating a step of manufacturing the battery relating to the present embodiment;

FIG. 8 is a schematic sectional view illustrating a step of manufacturing the battery relating to the present embodiment; and

FIG. 9 is a schematic sectional view illustrating a step of manufacturing the battery relating to the present embodiment.

### DETAILED DESCRIPTION

An embodiment relating to the present disclosure is described in detail hereinafter on the basis of the drawings. Note that, for convenience of explanation, arrow UP that is shown appropriately in the respective drawings indicates the vehicle upward direction, arrow FR indicates the vehicle frontward direction, and arrow LH indicates the vehicle leftward direction. Accordingly, in the following explanation, when vertical, longitudinal and left-right directions are mentioned, they refer to the vertical of the vehicle vertical direction, the longitudinal of the vehicle longitudinal direction, and the left-right of the vehicle left-right direction (the vehicle transverse direction), unless otherwise specified. Further, the left-right direction has the same meaning as the vehicle transverse direction.

The sizes of the members in the respective drawings are schematic, and the relative relationships of the sizes among the members are not limited to these. Further, in the present embodiment, a “step” is not only an independent step and includes steps that, even in a case in which that step cannot be clearly distinguished from another step, achieve the intended object of that step.

In the present embodiment, numerical value ranges expressed by using “˜” mean ranges in which the numerical values listed before and after the “˜” are included as the minimum value and maximum value, respectively. Further, in numerical value ranges that are expressed in a stepwise manner in the present embodiment, the maximum value or the minimum value listed in a given numerical value range may be substituted by the maximum value or the minimum value of another numerical value range that is expressed in a stepwise manner.

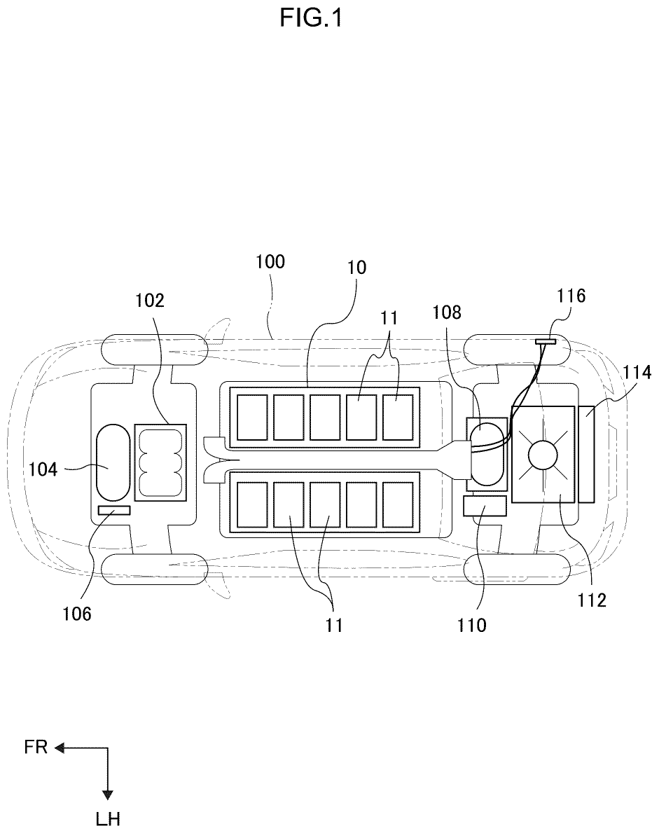

As illustrated in FIG. 1, vehicle 100 relating to the present embodiment is, as an example, an electric vehicle (a BEV: battery electric vehicle) in which a battery pack 10 is installed beneath the floor. Namely, batteries 20 relating to the present embodiment are installed in the vehicle 100. Note that, in the following explanation, there are cases in which the “battery 20” is described as the “battery cell 20”.

A DC/DC converter 102, an electric compressor 104 and a PTC (Positive Temperature Coefficient) heater 106 are disposed at the vehicle 100 at further toward the front side than the battery pack 10. A motor 108, a gear box 110, an inverter 112 and a charger 114 are disposed further toward the rear side than the battery pack 10.

Accordingly, after the voltage of the DC current outputted from the battery pack 10 is adjusted by the DC/DC converter 102, the DC current is supplied to the electric compressor 104, the PTC heater 106, the inverter 112 and the like. Further, due to electric power being supplied to the motor 108 via the inverter 112, the rear wheels rotate, and the vehicle 100 travels.

A charging port 116 is provided at the right side portion of the rear portion of the vehicle 100. Accordingly, due to a charging plug of an unillustrated, external charging equipment being connected to the charging port 116, electric power is stored in the battery pack 10 via the charger 114.

Note that, although the illustrated vehicle 100 is a rear-wheel-drive vehicle in which the motor 108 is installed at the rear portion of the vehicle 100, the present disclosure is not limited to this, and the vehicle may be a front-wheel-drive vehicle in which the motor 108 is installed in the front portion of the vehicle. Further, the vehicle may be a vehicle in which a pair of the motors 108 are installed with one at the front and one at the rear, or may be a vehicle in which in-wheel motors are provided at the respective wheels. Namely, the arrangement, the structures and the like of the respective parts that structure the vehicle 100 are not limited to the above-described structure.

The battery pack 10 is structured to include plural battery modules 11. In the present embodiment, as an example, ten of the battery modules 11 are provided.

Specifically, five of the battery modules 11 are lined-up at the right side of the vehicle 100 with the thickness directions thereof running along the longitudinal direction, and five of the battery modules 11 are lined-up at the left side of the vehicle 100 with the thickness directions thereof running along the longitudinal direction. Note that the respective battery modules 11 are electrically connected.

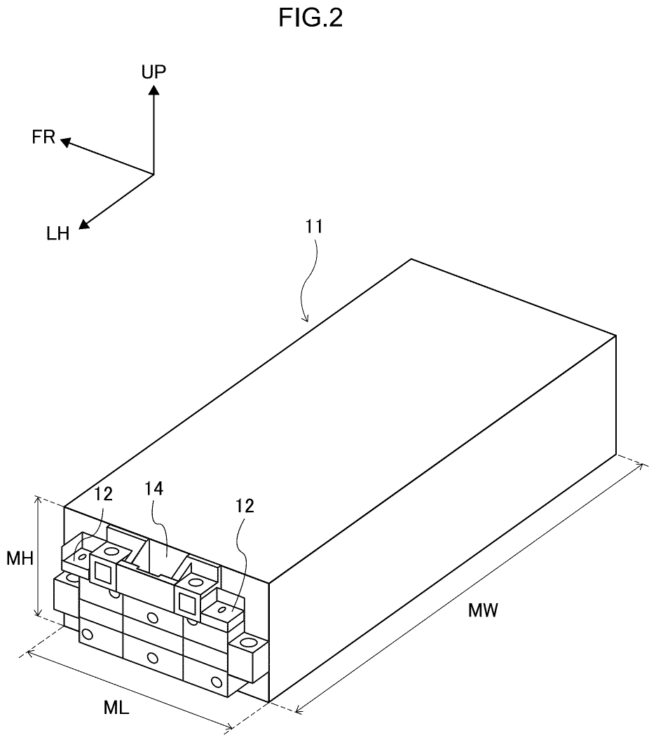

As illustrated in FIG. 2, the battery module 11 is formed substantially in the shape of a rectangular parallelopiped whose length direction is the vehicle transverse direction. The outer case of the battery module 11 is formed of an aluminum alloy. For example, the outer case of the battery module 11 is formed by aluminum die cast materials being joined by laser welding or the like to the both end portions of an extruded member that is an aluminum alloy.

A pair of voltage terminals 12 and a connector 14 are provided at each of the vehicle transverse direction both end portions of the battery module 11. A flexible printed board 21 that is described later is connected to the connectors 14. Further, unillustrated bus bars are welded to the vehicle transverse direction both end portions of the battery module 11.

Note that length MW of the battery module 11 in the vehicle transverse direction is 350 mm˜600 mm for example, and length ML in the longitudinal direction is 150 mm˜250 mm for example, and height MH in the vertical direction is 80 mm˜110 mm for example.

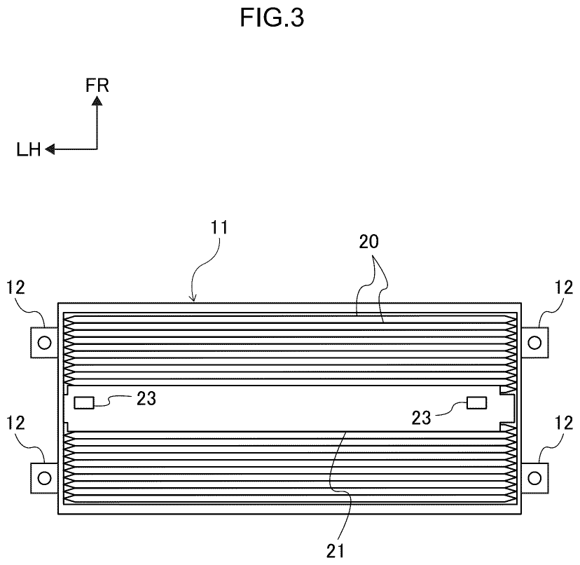

As illustrated in FIG. 3, the plural battery cells (batteries) 20 are accommodated at the interior of the battery module 11 so as to be lined-up with the thickness directions thereof running along the longitudinal direction. In the present embodiment, as an example, 24 of the battery cells 20 are lined-up with the thickness directions running along the longitudinal direction, and are welded together.

The flexible printed board (FPC: Flexible Printed Circuit) 21 is disposed at the upper side and the longitudinal direction central side of the battery cell 20. The flexible printed board 21 is formed in the shape of a strip whose length direction is the vehicle transverse direction. A thermistor 23 is provided at each of the both end portions of the flexible printed board 21. The thermistors 23 are not welded to the battery cell 20, and are pushed toward the battery cell 20 side by an upper cover of the battery module 11.

One or plural buffering members that are not illustrated are accommodated within the battery module 11. The buffering members are, for example, elastically deformable, thin-plate-shaped members, and are disposed between the battery cells 20 that are adjacent to one another such that the thickness directions thereof are the direction in which the battery cells 20 are lined-up. In the present embodiment, as an example, buffering members are disposed at the length direction both end portions and the length direction central portion of the battery module 11, respectively.

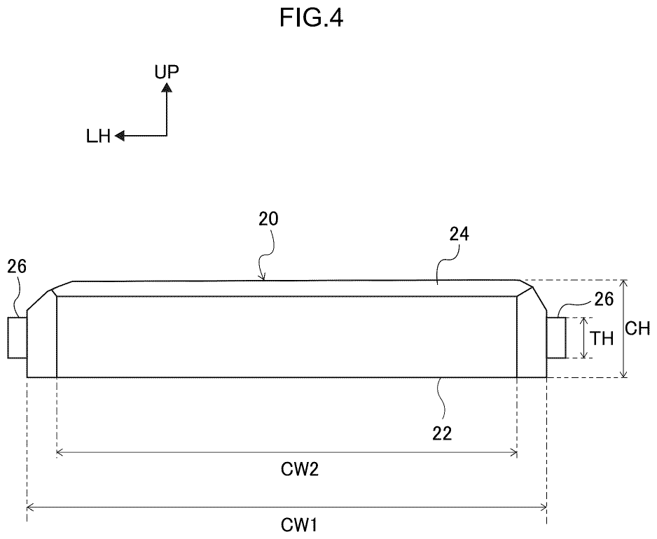

As illustrated in FIG. 4, the battery cell 20 is formed substantially in the shape of a rectangular plate, and an unillustrated electrode body is accommodated at the interior thereof. The electrode body is structured by electrodes (a negative electrode and a positive electrode) and a separator, which is disposed between the electrodes, being layered, and is sealed by a laminate film 22 that serves as an exterior body.

For example, a structure, in which a layer that contains an electrode active material is formed on one surface or both surfaces of a collector, is used as the electrode. A microporous film formed from a resin such as polyethylene or the like for example is used as the separator. The laminate film 22 is a layered body having a metal layer, which contains a metal such as aluminum or the like, and a heat sealing layer.

In the present embodiment, as an example, the accommodating portion of the electrode body is formed by the laminate film 22, which is shaped as a sheet and is embossed, being folded over and portions thereof affixed together. Note that both a single cup embossed structure in which embossing is carried out at one place, and a double cup embossed structure in which embossing is carried out at two places, can be employed for the laminate film 22. A single cup embossed structure of a draw depth of around 8 mm˜10 mm is illustrated in FIG. 4.

The upper ends at the length direction both end portions of the battery cell 20 illustrated in FIG. 4 are folded over, and the upper end portion of the battery cell 20 also is folded over so as to be continuous with the folded-over regions. Further, a fixing tape 24 is wound on the upper end portion of the battery cell 20 along the length direction.

A terminal (tab) 26 is provided at each of the length direction both end portions of the battery cell 20. In the present embodiment, as an example, the respective terminals 26 are provided at positions that are offset further toward the lower side than the central portion in the vertical direction of the battery cell 20. The respective terminals 26 are joined to the unillustrated bus bars respectively by laser welding or the like.

Note that length CW1 of the battery cell 20 in the vehicle transverse direction is, for example, 530 mm˜600 mm, 600 mm˜700 mm, 700 mm˜800 mm, 800˜900 mm, or greater than or equal to 1000 mm. Length CW2 of the region where the electrode body is accommodated is, for example, 500 mm˜520 mm, 600 mm˜700 mm, 700 mm˜800 mm, 800˜900 mm, or greater than or equal to 1000 mm.

Height CH of the battery cell 20 is, for example, 80 mm˜110 mm, or 110 mm˜140 mm. The thickness of the battery cell 20 is 5.0 mm˜7.0 mm, 7.0 mm˜9.0 mm, or 9.0 mm˜11.0 mm. Height TH of the terminals 26 is 40 mm˜50 mm, 50 mm˜60 mm, or 60 mm˜70 mm.

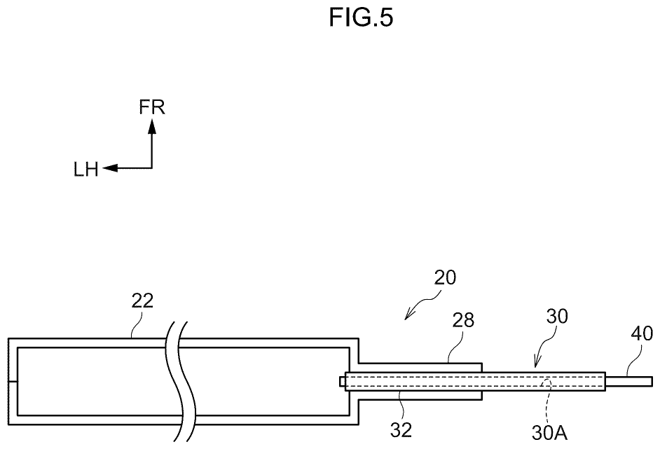

A method of manufacturing the battery (battery cell) 20 that is structured as described above is described next. Note that the battery 20 that is illustrated in FIG. 5 through FIG. 9 is a schematic illustration of a planar section of the battery cell 20 illustrated in FIG. 4.

The battery 20 that is manufactured by the manufacturing method relating to the present embodiment is a so-called laminated battery that uses the laminate film 22 as the exterior body thereof. First, an unillustrated electrode body is accommodated at the interior of the laminate film 22, and thereafter, the laminate film 22 is folded over in two, and the heat sealing layers of peripheral edge portions 28 that are superposed one on another are joined (welded) together.

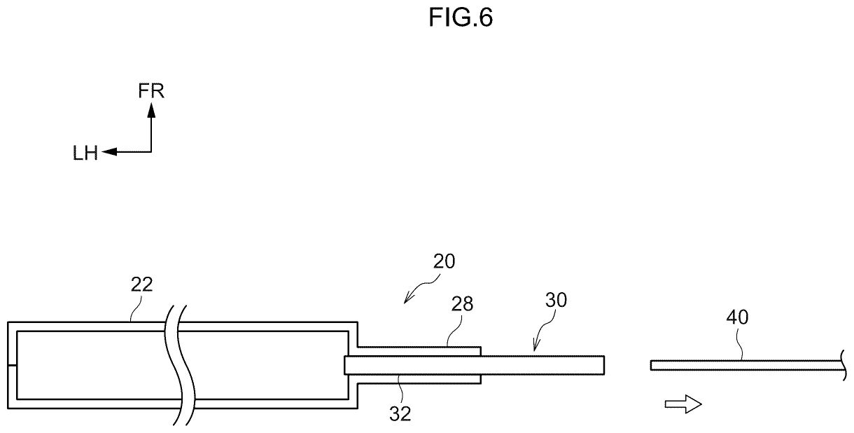

At this time, as illustrated in FIG. 5, one end portion 32 of a hollow member 30, which is formed in the shape of a cylindrical tube of a low melting point resin material, is nipped and welded between the heat sealing layers of the peripheral edge portions 28, which are superposed one on the other, of the laminate film 22 (joining step). At this time, the hollow member 30 is welded between the heat sealing layers of the peripheral edge portions 28 of the laminate film 22 in a state in which a rod-shaped member 40, which is made of metal and passes-through the entire length of a supply path 30A that includes the one end portion 32, is inserted through the hollow member 30. Then, as illustrated in FIG. 6, this rod-shaped member 40 is pulled out after the welding.

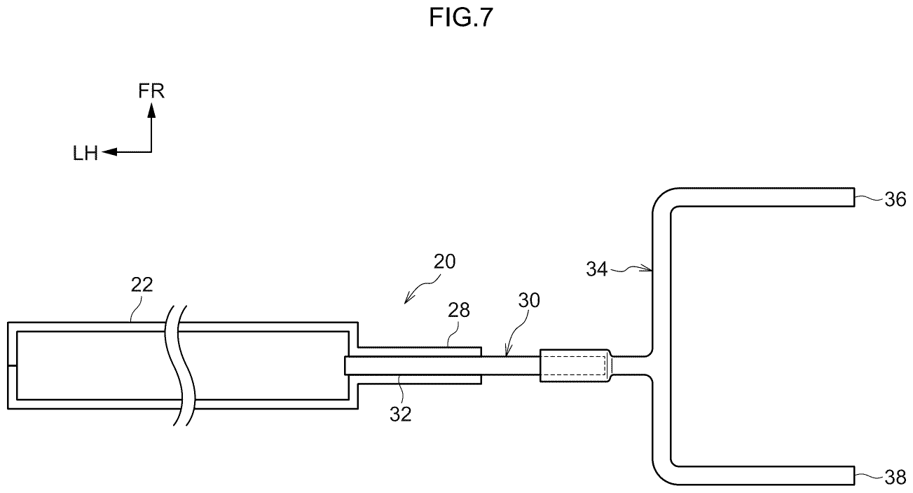

When the interior and the exterior of the laminate film 22 are communicated by the hollow member 30 in this way, as illustrated in FIG. 7, a hollow extension member 34 that is bifurcated for example is connected to the hollow member 30. Then, first, the air at the interior of the laminate film 22 is removed from a one opening portion 36 side, and the pressure at the interior of the laminate film 22 is reduced (pressure-reducing step). Next, an unillustrated electrolytic solution is injected from another opening portion 38 side (injected due to the difference in pressure). Namely, the electrolytic solution is supplied from the supply path 30A (see FIG. 5) of the hollow member 30 into the interior of the laminate film 22 (supplying step).

When the supplying of the electrolytic solution into the interior of the laminate film 22 is finished, the hollow extension member 34 is removed from the hollow member 30.

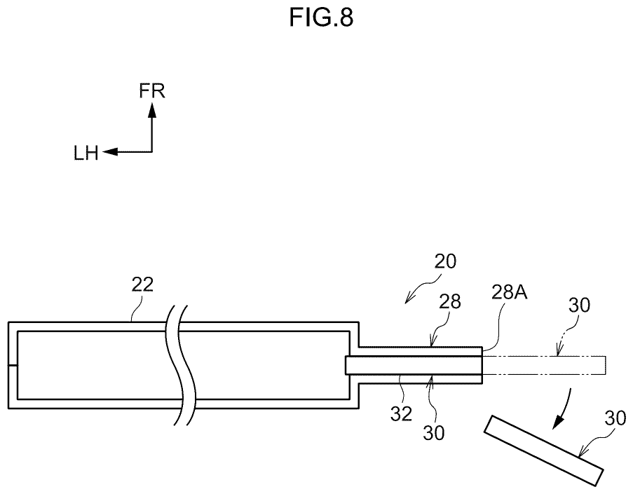

Then, as illustrated in FIG. 8, the portion of the hollow member 30 that is projecting out from the peripheral edge portions 28 of the laminate film 22 (the remaining portion that is other than the one end portion 32) is cut from the base thereof (so as to be flush with end surfaces 28A which are the cut surfaces of the peripheral edge portions 28) (cutting step).

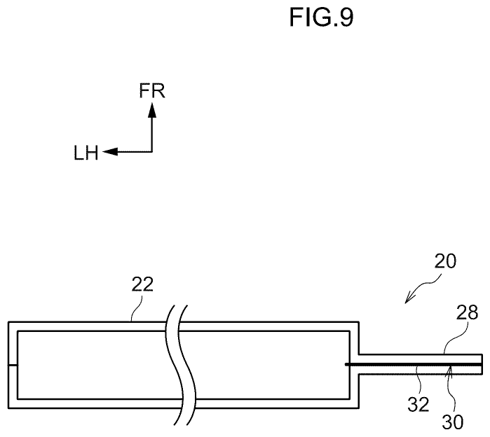

Thereafter, as illustrated in FIG. 9, the one end portion 32 of the hollow member 30, which is nipped and remains between the heat sealing layers at the peripheral edge portions 28 of the laminate film 22, is crushed and welded (the supply path 30A is closed-off), and the laminate film 22 is sealed (sealing step). The battery 20 is manufactured by the above-described steps.

Note that the low melting point resin material that is used for the hollow member 30 is a resin material that has a higher melting point than the melting point of the heat sealing layers (e.g., low-density polyethylene layers) at the peripheral edge portions 28 of the laminate film 22, and polypropylene and the like are examples thereof. Further, the outer diameter of the rod-shaped member 40 is substantially the same as the inner diameter of the hollow member 30. Accordingly, in the joining step, the outer peripheral surface of the one end portion 32 of the hollow member 30 is welded in a state of being fit tightly to the heat sealing layers at the peripheral edge portions 28 of the laminate film 22. Further, the above-described manufacturing method can be applied also to cases of injecting an electrolytic solution over plural times or a case of additionally injecting an electrolytic solution.

Operation of the battery 20 and the method of manufacturing thereof, which relate to the present embodiment and are structured as described above, is described hereinafter.

As described above, the one end portion 32 of the hollow member 30 is nipped and welded between the heat sealing layers of the peripheral edge portions 28 of the laminate film 22 that accommodates an electrode body at the interior thereof. Therefore, an electrolytic solution can be supplied into the interior of the laminate film 22 from the supply path 30A of the hollow member 30. Accordingly, as compared with a case in which the injection port is structured by an unsealed portion of the laminate film 22, there is no need for a step for removing adhered matter that has adhered to the injection port, and the work of injecting an electrolytic solution into the interior of the laminate film 22 can be carried out easily.

At the time of welding the one end portion 32 of the hollow member 30 between the heat sealing layers of the peripheral edge portions 28 of the laminate film 22, the welding is carried out in a state in which the rod-shaped member 40 is inserted-through the supply path 30A that includes this one end portion 32. Accordingly, the one end portion 32 of the hollow member 30 can be welded in a state of being fit tightly between the heat sealing layers of the peripheral edge portions 28 of the laminate film 22, in a state in which the supply path 30A of the hollow member 30 is ensured properly.

Further, by pulling the rod-shaped member 40 out after the welding, the interior and the exterior of the laminate film 22 can be communicated properly by the hollow member 30. Further, after the rod-shaped member 40 is pulled out, the pressure of the interior of the laminate film 22 is reduced. Accordingly, the electrolytic solution can smoothly flow into the interior of the laminate film 22. In other words, the electrolytic solution can be supplied smoothly into the interior of the laminate film 22.

Further, after the electrolytic solution is supplied into the interior of the laminate film 22, the portion of the hollow member 30 that is projecting out from the peripheral edge portions 28 is cut, and then, the one end portion 32 of the hollow member 30 that is nipped and remains between the heat sealing layers at the peripheral edge portions 28 is crushed and welded (the supply path 30A is closed-off), and the laminate film 22 is sealed. Accordingly, the battery 20 that is manufactured can be structured so as to be compact as before, and the ability to save on space when the battery 20 is accommodated within the battery module 11 can be maintained.

Note that the melting point of the resin material that structures the hollow member 30 is higher than the melting point of the heat sealing layers at the peripheral edge portions 28 of the laminate film 22. Therefore, at the time of joining (welding) the heat sealing layers of the peripheral edge portions 28 of the laminate film 22 in the state in which the one end portion 32 of the hollow member 30 is nipped therebetween, there is no concern that the problem of the one end portion 32 of the hollow member 30 melting will arise.

Further, the hollow member 30 is formed of a low melting point resin material such as polypropylene or the like for example. Therefore, after the electrolytic solution is supplied into the interior of the laminate film 22, the welding of the one end portion 32 of this hollow member 30 (the closing-off of the supply path 30A) can be carried out easily, and the sealing of the laminate film 22 can be carried out easily.

Although the battery 20 and the method of manufacturing thereof relating to the present embodiment have been described above on the basis of the drawings, the battery 20 and the method of manufacturing thereof relating to the present embodiment are not limited to the illustrated structures, and the designs thereof can be changed appropriately within a scope that does not depart from the gist of the present invention. For example, the type of the exterior body is not limited to the laminate film 22.

Namely, the exterior body is not particularly limited, provided that it can accommodate an electrode body and that the melting point of the peripheral edge portions thereof is lower than the melting point of the hollow member 30. Further, the exterior body may be structured from a single member, or may be structured from two or more members. For example, in a case in which the exterior body is sheet-shaped, the exterior body may be structured from a single sheet, or may be structured from two or more sheets.

Further, the type and the size of the electrode body are not particularly limited and can be selected in accordance with the scale and the application of the battery 20. Further, the numbers of the electrodes and separators that are included in the electrode body also are not particularly limited, and are selected appropriately in accordance with the scale and the application of the battery 20. Further, the vehicle 100 is not limited to an electric vehicle. The vehicle 100 may be, for example, a hybrid vehicle (HV) or a plug-in hybrid electric vehicle (PHEV) that is equipped with an engine.

What is claimed is:

1. A battery comprising:
an exterior body that accommodates an electrode body at an interior of the exterior body, and at which superposed peripheral edge portions are joined together; and
a resin hollow member having a supply path for supplying an electrolytic solution into the interior of the exterior body, and nipped between the superposed peripheral edge portions of the exterior body, and welded to the peripheral edge portions.

2. The battery of claim 1, wherein a melting point of a resin material configuring the hollow member is higher than a melting point of the peripheral edge portions.

3. A method of manufacturing a battery, comprising:
joining together superposed peripheral edge portions of an exterior body that accommodates an electrode body at an interior of the exterior body, and nipping and welding one end portion of a hollow member between the peripheral edge portions; and
supplying an electrolytic solution into the interior of the exterior body from a supply path of the hollow member.

4. The method of manufacturing a battery of claim 3, wherein the hollow member is welded between the peripheral edge portions in a state in which a rod-shaped member is inserted through the supply path that includes the one end portion, and, after welding, the rod-shaped member is pulled out.

5. The method of manufacturing a battery of claim 4, comprising, after pulling the rod-shaped member out, reducing pressure of the interior of the exterior body.

6. The method of manufacturing a battery of claim 3, comprising:
after supplying the electrolytic solution into the interior of the exterior body, cutting the hollow member that is projecting out from the peripheral edge portions; and
crushing and welding the one end portion of the hollow member that is nipped and remains between the peripheral edge portions, and sealing the exterior body.

7. The method of manufacturing a battery of claim 4, comprising:
after supplying the electrolytic solution into the interior of the exterior body, cutting the hollow member that is projecting out from the peripheral edge portions; and
crushing and welding the one end portion of the hollow member that is nipped and remains between the peripheral edge portions, and sealing the exterior body.

8. The method of manufacturing a battery of claim 5, comprising:
after supplying the electrolytic solution into the interior of the exterior body, cutting the hollow member that is projecting out from the peripheral edge portions; and
crushing and welding the one end portion of the hollow member that is nipped and remains between the peripheral edge portions, and sealing the exterior body.
